(19) United States
(12) Patent Application Publication
(10) Pub. No.: US 2005/0140096 A1
(43) Pub. Date: Jun. 30, 2005

(54) Multilayer gasket containing at least one shim of increased thickness

(76) Inventors: Christoph Golombek, Weinheim (DE); Damien Guerin, Stuttgart (DE); Christian Kebaili, Limoges (FR)

Correspondence Address: HARNESS, DICKEY & PIERCE, P.L.C., P.O. BOX 828, BLOOMFIELD HILLS, MI, 48303, US

(21) Appl. No.: 10/949,728

(22) Filed: Sep. 24, 2004

(30) Foreign Application Priority Data
Oct. 2, 2003 (FR) 03 50634

(51) Int. Cl. F02F 11/00

(52) U.S. Cl. 277/594

(57) ABSTRACT

A cylinder head gasket with at least one opening corresponding to a combustion chamber. The gasket comprises a stack of at least one sheet, referred to as the active sheet, that comprises at least one rib surrounding said opening(s), and at least one interposed sheet, wherein the gasket comprises at least one shim of increased thickness and disposed in the plane of the interposed sheet opposite the active sheet or active sheets, and outside the rib or ribs. The shim of increased thickness has a thickness such that it constitutes a localized increased thickness compared to the interposed sheet.

The present invention relates to a multilayer gasket containing at least one shim of increased thickness, and more particularly to a multilayer metallic cylinder head gasket.

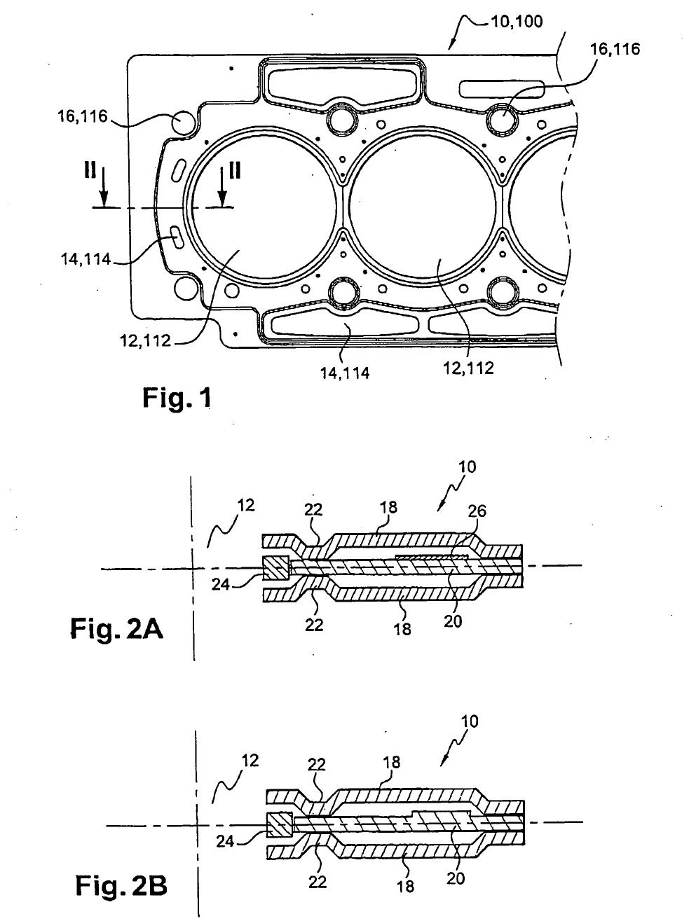

A cylinder head gasket is used to ensure tight sealing between an engine block and a cylinder head. As shown in FIG. 1, a cylinder head gasket 10 generally has the same shape as the engine block, particularly a rectangular shape, and comprises a plurality of openings ensuring the continuity between the cavities or conduits disposed, on one hand, in the engine block and, on the other, in the cylinder head. Thus, the first openings 12 are intended for the combustion chambers, the second openings 14 for the conduits for the coolant or coolants, and the third openings 16 to permit the passage of elements for fixing the cylinder head to the engine block, particularly of threaded pins. Thus, the cylinder head gasket must ensure good sealing between the conduits themselves and between the conduits and the outside despite geometric flaws on the contact surfaces between the engine block and the cylinder head and despite temperature variations.

According to one common embodiment illustrated in FIGS. 2A and 2B, a cylinder head gasket 10 contains several stacked leaves or sheets, and particularly two active outer sheets 18 in between which is disposed an interposed sheet 20. At least one of the outer sheets 18 comprises a rib 22 which extends around the first openings 12, in the vicinity of said openings, and is oriented toward the inside of the gasket, so as to obtain a deformable zone making it possible to compensate for gasket deformations. Thus, when ribs 22 are provided on the outer sheets 18, the projecting parts of said ribs face each other and are oriented one toward the other or in opposition to one another.

To improve tightness, said gasket 10 contains a shim 24 referred to as the stopper and disposed at the periphery of first openings 12 provided for the combustion chambers and disposed edge-to-edge with interposed sheet 20. Said stopper 24 is slightly thicker than interposed sheet 20 thus, on the one hand, permitting to achieve a higher tightening stress around the combustion chambers and, on the other, to obtain a prestress on at least one of the outer sheets 18 so as to reduce the displacement amplitude and the squeezing of the ribs.

Depending on the arrangement of the tightening elements, the stopper can have variable thickness to ensure uniform distribution of the tightening stress on the periphery of openings 12 provided for the combustion chambers. The presence of a stopper 24 which is always thicker than interposed sheet 20 causes mechanical stresses at the level of outer sheets 18 because of the jamming of said outer sheets at the instant of tightening. On the other hand, to achieve good tightness it is necessary to exert uniform tightening pressure on the entire surface of the cylinder head gasket 10.

Thus, to solve these problems, localized shims of increased thickness are therefore provided at the level of the interposed sheet in the zone referred to as the no gas zone, namely on the outside of ribs 22, making it possible to reduce the stresses and to obtain uniform tightening pressure on the entire gasket surface.

According to a first known embodiment, illustrated in FIG. 2A, the increased thickness is obtained by inserting on the surface of interposed sheet 20 a shim 26 or thin sheet, having a thickness of less than or equal to 0.1 mm. This solution is not satisfactory, because such a shim has the tendency to bend which complicates its placement. In addition, to be fully effective the shim must be mechanically linked to the interposed sheet. The fixation of an extremely thin element is relatively complicated and costly.

According to a second known embodiment illustrated in FIG. 2B, the increased thickness is obtained by stamping the interposed sheet 20 so as to impart to it a variable thickness. This solution is also not satisfactory, because the stamping of a sheet for the purpose of imparting to it variable localized thicknesses is relatively complicated and costly. Moreover, this stamping technique, unlike the lamination technique, does not allow one to obtain thicknesses of accurate dimensions.

The purpose of the present invention therefore is to overcome the drawbacks of the prior art by providing a multilayer gasket with an interposed sheet of localized variable thickness and of simple design and which can be brought into operation easily and in a relatively less costly manner.

Hence, the invention has for an object a cylinder head gasket with at least one opening corresponding to a combustion chamber, said gasket comprising a stack of at least one sheet referred to as the active sheet and containing at least one rib disposed around said opening or openings, and at least one interposed sheet, characterized in that it comprises at least one shim referred to as being of increased thickness and disposed in the plane of the interposed sheet, opposite the active sheet or sheets, outside the rib or ribs, said shim of increased thickness having a thickness such that it constitutes a localized increased thickness compared to the interposed sheet.

Advantageously, the shim of increased thickness is disposed in a recess made in the interposed sheet, the shape of the interposed shim matching that of the recess in which it is lodged. This arrangement permits better immobilization of the shim of increased thickness.

Preferably, the recess is open. This variant has the advantage of simplifying the operation and of obtaining an increased thickness accurately matching that of the shim of increased thickness obtained by lamination.

The invention also proposes a method for providing increased thickness in an interposed sheet of a cylinder head gasket.

Other features and advantages will become obvious from the following description of the invention, said description being provided only as an example, and with reference to the attached drawings in which:

FIG. 1 shows a top view in elevation of a cylinder head gasket,

FIG. 2A shows a section along line II-II of FIG. 1 of a first embodiment of the prior art,

FIG. 2B shows a section along line II-II of FIG. 1 of a second embodiment of the prior art,

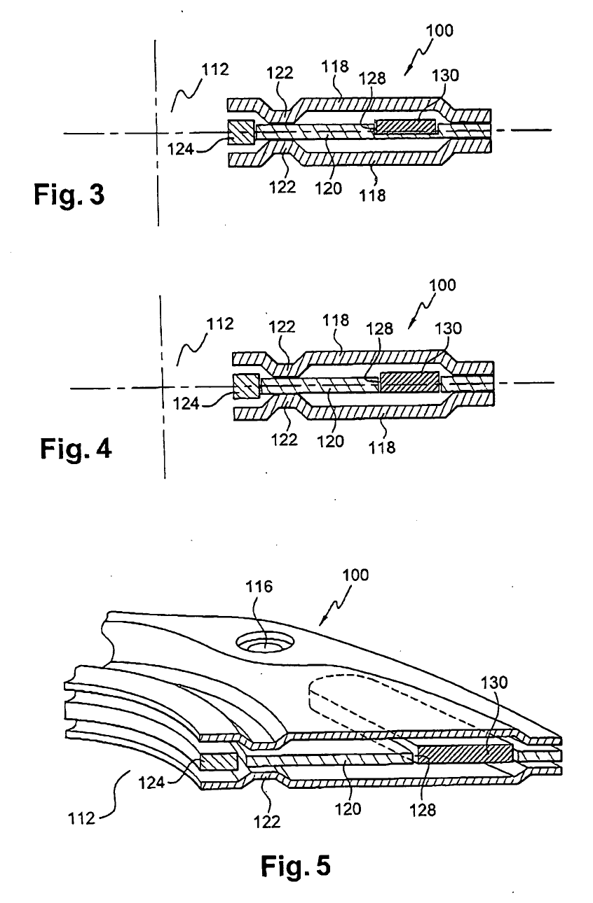

FIG. 3 shows a section along line II-II of FIG. 1 of a first embodiment of the invention,

FIG. 4 shows a section along line II-II of FIG. 1 of a second embodiment of the invention,

FIG. 5 shows a view in perspective and a sectional view of the gasket of FIG. 4,

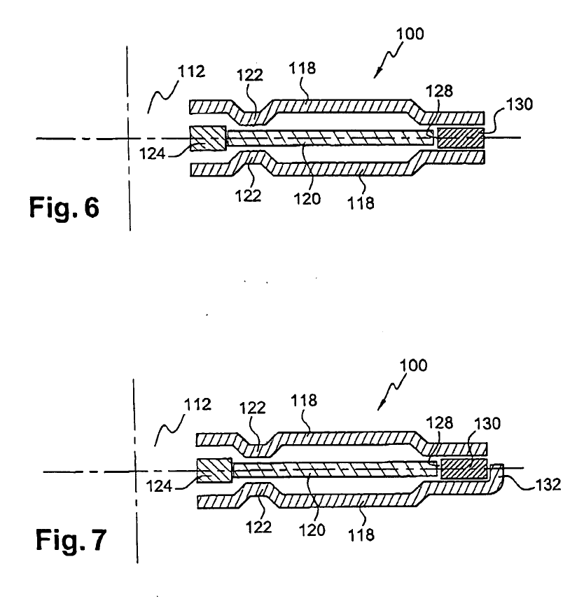

FIG. 6 shows a sectional view illustrating the embodiment of a gasket with a shim of increased thickness disposed at the periphery of the gasket, and

FIG. 7 shows a sectional view illustrating another variant of a method of fixation of a shim of increased thickness disposed at the periphery of the gasket.

FIG. 1 shows a cylinder head gasket 100.

This type of gasket interposed between an engine block and a cylinder head comprises a plurality of openings to ensure continuity between the cavities and the conduits provided in said engine block and said cylinder head. Thus, cylinder head gasket 100 must ensure tight sealing of the cavities or conduits themselves or between them and the outside.

In the following description, elements which the present invention and the variants of the prior art have in common bear the same reference numerals but increased by 100.

Thus, as illustrated in the different figures, cylinder head gasket 100 contains first openings 112 intended for the combustion chambers, second openings 114 intended for the coolant conduits, and third openings 116 intended for the passage of elements of fixation of the cylinder head to the engine block, particularly of threaded pins.

Said cylinder head gasket 100 contains several stacked leaves or sheets, particularly active outer sheets 118 between which is disposed an interposed sheet 120. At least one of outer sheets 118 comprises a rib 122 extending around first openings 112, in the vicinity of said openings, and oriented toward the inside of the gasket to obtain a deformable zone for compensation of gasket deformations. Thus, when ribs 122 are provided on the two outer sheets 118, the projecting parts of said ribs are preferably disposed opposite each other and oriented toward each other. Hence, rib or ribs 122 delimit two zones, a first zone inside the rib or ribs and a second zone outside the rib or ribs 122, referred to as the no gas zone.

To improve sealing, said gasket 110 comprises a shim 124 called a stopper, which is thicker than interposed sheet 120 and is disposed at the periphery of first openings 112 and edge-to-edge with interposed sheet 120.

According to the invention, gasket 110 comprises at least one shim 130 referred to as the shim of increased thickness, disposed in the plane of interposed sheet 120, opposite active sheet or active sheets 118, outside the rib or ribs, said shim of increased thickness having a thickness such that it constitutes a localized increased thickness compared to interposed sheet 120.

By being “disposed in the plane of interposed sheet 120” is meant that part of the shim of increased thickness 130 can come in contact with at least one part of the section of interposed sheet 120, the section corresponding either to the peripheral edge of the interposed sheet or to the edge of a recess or hollow provided in the interposed sheet.

By being “disposed opposite the active sheet or sheets 118” is meant that part of the shim of increased thickness 130 can come in contact with at least one active sheet or that it is disposed between two active sheets.

Preferably, shim of increased thickness 130 is disposed in a recess or hollow 128 provided in interposed sheet 120.

Advantageously, the shape of the shim of increased thickness 130 matches that of recess 128 receiving it. This limits the relative movements in the plane of interposed sheet 120.

In terms of translation, shim of increased thickness 130 is immobilized by the edges of recess 128 and is thicker than a shim 26 of the prior art, which facilitates its use. In general, a machining operation to remove material so as to provide a recess or hollow is relatively simpler and less costly than carrying out a stamping operation.

Depending on the case, recess 128 may be not open as illustrated in FIG. 3 or open as illustrated in FIG. 4. This second variant has the advantage of simplifying the method of operation and that of making it possible to obtain an increased thickness that accurately corresponds to that of the shim of increased thickness 130 obtained by lamination.

FIG. 5 shows the second variant in perspective.

In accordance with the prior art, the increased thickness provided by shim 130 makes it possible to reduce the mechanical stresses at the level of outer sheets 118 and to obtain a uniform tightening pressure on the entire surface of the gasket.

According to a preferred embodiment, recesses 128 provided in interposed sheet 120 are obtained by punching, preferably during the cutting of openings 112, 114 and 116. Furthermore, the shims of increased thickness 130 can also be obtained by punching. They can have contours of different shapes.

In contrast to a shim that must be fixed to the interposed sheet by an appropriate means to makes sure it does not move, shim of increased thickness 130 is simply immobilized in its recess 128 so that fixation is no longer needed. As a variant, shim of increased thickness 130 can be disposed at the level of the edges of the gasket, at the periphery of interposed sheet 120, as illustrated in FIGS. 6 and 7.

In this case, the edges of hollow 128 provided in interposed sheet 120 may not be sufficient to immobilize shim of increased thickness 130.

According to a first variant, shim 130 can be fixed to interposed sheet 120 by any appropriate means, particularly by welding, as illustrated in FIG. 6.

According to another variant, shim of increased thickness 130 can be fixed to one of the active sheets by any appropriate means, particularly by welding.

According to another variant, shim 130 can be immobilized in simple manner by providing at least one of outer sheets 118 with a bent edge 132, as illustrated in FIG. 7.

In some cases, particularly when the shim of increased thickness is disposed at the periphery of interposed sheet 120, said sheet may not contain a recess 128 but may simply have smaller dimensions than the active sheet.

The most convincing results are obtained when shim of increased thickness 130 is disposed at the periphery of interposed sheet 120.

These results can be improved further by combining a shim of increased thickness disposed at the periphery of the interposed sheet with shims of increased thicknesss disposed around the screw passages 116. Thus, according to the invention, the shim of increased thickness can present a hole permitting the passage of a screw. This solution has the advantage of achieving immobilization of the shim of increased thickness between the active sheets and of not linking said shim of increased thickness with one of the active sheets or the interposed sheet in a mechanical manner, for example by welding.

It will be understood that the invention is not limited to the embodiments represented and described hereinabove, but that, on the contrary, it covers all variants, particularly as regards the shapes, dimensions and materials of the different elements constituting the gasket.

Moreover, the invention can also be applied to gaskets with a single active sheet and/or with or without a stopper.

Finally, as another variant it is possible to envisage a stopper and an interposed sheet all in one piece, the stopper being obtained as a result of increased thickness at the level of the opening intended for the combustion chambers, particularly by bending the interposed sheet.

The entire disclosure of French Patent Application 03 50634 filed 2 Oct. 2003, is hereby incorporated by reference.

1. A cylinder head gasket with at least one opening corresponding to a combustion chamber, said gasket comprising:
a stack of at least one active sheet, said active sheet including at least one rib that extends around the opening, and at least one interposed sheet; and
at least one shim of increased thickness, said shim of increased thickness disposed in a plane of said interposed sheet opposite said active sheet and outside said rib;
wherein said shim of increased thickness has a thickness such that it constitutes a localized increased thickness compared to said interposed sheet.

2. The cylinder head gasket according to claim 1, wherein said interposed sheet comprises at least one hollow or recess capable of receiving at least one shim of increased thickness.

3. The cylinder head gasket according to claim 2, wherein a shape of said shim of increased thickness matches that of said hollow or recess receiving it.

4. The cylinder head gasket according to claim 2, wherein said recess is open.

5. The cylinder head gasket according to claim 1, wherein said shim of increased thickness is disposed at a periphery of said interposed sheet.

6. The cylinder head gasket according to claim 5, wherein said at least one outer sheet comprises a bent edge that immobilizes said shim of increased thickness.

7. A method for creating an increased thickness in an interposed sheet incorporated in a cylinder head gasket, said gasket comprising a stack of at least one active sheet containing at least one rib provided around at least one opening that corresponds to a combustion chamber, and at least the said inter-posed sheet, said method comprising:
creating at least one recess or hollow in a zone disposed outside the rib or ribs; and
disposing in said recess a shim having a thickness such that it constitutes a localized increased thickness compared to the interposed sheet.

8. The method according to claim 7, wherein one open recess is provided.

9. The method according to claim 7, wherein said at least one recess is obtained by punching.

10. The Method according to claim 7, wherein said at least one recess is disposed at a periphery of the interposed sheet.

11. The Method according to claim 10, wherein a bend at a peripheral edge of at least one active sheet is provided so as to immobilize a shim of increased thickness disposed at the periphery of the interposed sheet.
